(19) United States
(12) Patent Application Publication
(10) Pub. No.: US 2004/0111610 A1
(43) Pub. Date: Jun. 10, 2004

(54) Secure file format

(75) Inventors: Royce E. Slick, Mission Viejo, CA (US); Neil Y. Iwamoto, Mission Viejo, CA (US); Craig Mazzagatte, Aliso Viejo, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/310,189

(22) Filed: Dec. 5, 2002

(51) Int. Cl. H04L 9/00

(52) U.S. Cl. 713/160

(57) ABSTRACT

A file format for a secure file having a secure client header and a data block appended to the secure client header. The client header has a client information block comprised of a public information block and a private information block, wherein at least a portion of the private information block is encrypted, and a client information block integrity check value appended to the client information block, the client information block integrity check value being obtained by performing an integrity check on the client information block. The data block is preferably encrypted and is comprised of a plurality of encrypted data blocks each appended with its own respective integrity check result value. Each of the plurality of data blocks and their respective integrity check result values are obtained by dividing the encrypted data block into n encrypted data blocks, performing an integrity check on a fist one of the n encrypted data blocks and the client information integrity check result value appended to the client information block so as to obtain a first encrypted data block integrity check result value, appending the first encrypted data block integrity check result value to the first encrypted data block, and repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

### INCORPORATION BY REFERENCE

U.S. patent application Ser. No. 10/010,974, filed on Dec. 5, 2001, entitled “Secure Printing With Authenticated Printer Key” is hereby incorporated by reference as if set forth in full herein.

### BACKGROUND OF THE INVENTION

1. Field of the Invention

The present invention concerns creation of secure files. More particularly, the present invention concerns a secure file format having a secure client header, a secure client header integrity check value appended thereto, and an encrypted data block appended thereto, wherein the secure client header includes a public information block and an encrypted private information block, and the encrypted data block is comprised of a plurality of encrypted data blocks each appended with a respective integrity check value obtained by performing an integrity check of the data block and a previous integrity check value.

2. Description of the Related Art

Various data encryption techniques are known to be utilized in the realm of cryptography, and in particular, with secure network printing. For example, it has been known to use cryptography techniques involving the use of public/private key pairs, or any one of a number of hashing algorithms or secure protocols. The public/private key technique typically involves encrypting print data with a symmetric key, encrypting the symmetric key with the public key of the printer, and transmitting the encrypted data to the printer. Hashing algorithms are typically utilized to create a hash value that is appended to the print data and used in the printer to verify the integrity of the print data. Secure protocols, such as SSL (Secure Sockets Layer) have also been utilized in an attempt to provide security in transmission of print jobs. While each of the foregoing techniques provide at least some level of security, they are not without their drawbacks.

In this regard, depending on the specific implementation of the encryption and other cryptographic features, a variety of attacks may be mounted by an attacker. For example, if a stream cipher is used to encrypt the print job and the same key is reused between jobs, an attacker can employ techniques that allow portions of cleartext data to be recovered. Such an attack may be extended to a single job, where multiple fields are encrypted using the same key. If the keys that are used to encrypt data are easily predictable or only weakly random, an attacker will have a good chance of recovering the cleartext of the entire job.

Another type of attack might attempt to substitute all or part of the job with data provided by the attacker, thereby causing different content to be printed. Moreover, the attacker may attempt to corrupt the job in such a way that the printer, while attempting to process the job, is forced to expend a large amount of processing resources, causing denial of service to other users.

There may also be features in the job that identify the sender of the print job. An attacker may substitute a false identification for the sender of the job. If the printing system tracks users so as to charge the user for use of the printer's resources, the wrong person or department may be charged.

Thus, while known techniques provide at least some level of security, they are not without their drawbacks and the present invention aims to address at least some of these drawbacks by providing a secure file format that is different from those already known.

### SUMMARY OF THE INVENTION

The present invention provides a secure file format having a secure client header, a client header integrity check value appended thereto, and an encrypted data portion. The secure client header is preferably comprised of a public information block and a private information block, where at least a portion of the private information block is encrypted. The public information block preferably includes public information such as algorithms to be used for a public key, a symmetric key, a signature key and a hash algorithm. The private information block preferably includes private information such as the symmetric key itself and a hash key, both of which are encrypted. The client header is then subjected to an integrity check, such as HMAC (Hashing Message Authentication Code), to generate an integrity check value that is appended to the client header. With the client header being generated in this manner, the information to be utilized in decrypting the file is provided in the header in a secure manner and a device, such as a printer receiving the secure file, can process the file to decrypt the data. In this regard, the data portion can merely be encrypted utilizing, for example, a symmetric key, with the symmetric key being further encrypted with the printer's public key, and no other encryption techniques are necessary to provide the desired level of data privacy. However, in another aspect of the invention, the data portion is processed in a unique manner to provide even further security.

With this additional aspect, the encrypted data portion is further processed by dividing the data into a plurality of blocks. Each of the plurality of blocks are then processed by being subjected to an integrity check, such as HMAC, to obtain an integrity check value for each block that is appended thereto. However, each block is subjected to the integrity check in a daisy chain fashion in conjunction with an integrity check value from the previous integrity check. That is, the first data block of the plurality of blocks is subjected to an integrity check in conjunction with the integrity check value appended to the secure client header, thereby resulting in an integrity check value for the first data block that is appended to the first data block. The second data block is then subjected to an integrity check in conjunction with the integrity check value appended to the first data block, thereby resulting in an integrity check value for the second data block that is then appended to the second data block. The third and subsequent data blocks are in turn processed in like manner so as to form a daisy chain of data blocks and appended integrity check values. Thus, with the data portion being processed in this manner, even further security can be provided for.

Thus, in one aspect of the invention, a secure file comprised of a secure client header and a data block is created by generating the secure client header by forming a client information block comprised of a public information block and a private information block, encrypting at least a portion of the private information block of the client information block, performing an integrity check on the client information block to obtain a client information integrity check result value, and appending the client information integrity check result value to the client information block, thus creating the secure client header. The data block is then appended to the secure client header to obtain the secure file.

In a related aspect, the encrypted data block is divided into n encrypted data blocks, an integrity check is performed for a first one of the n encrypted data blocks and the client information integrity check result value appended to the client information block so as to obtain a first encrypted data block integrity check result value, with the first encrypted data block integrity check result value being appended to the first encrypted data block. The remaining data blocks are processed by repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

In other aspects, the client information block may further comprise a routing information block, wherein at least a portion of the routing information block is encrypted before the integrity check is performed. The routing information block may be utilized where the secure file is intended to be accessed only by a recipient identified in the header. Thus, the routing information block may comprise at least one of sender identification information, recipient identification information, a password, and job identification information, with at least the password and the job identification information being optionally encrypted.

Additionally, the public information block may comprise at least one of a public key algorithm, a symmetric key algorithm, a signature key algorithm and a hash algorithm, and the private information block may comprise at least one of a symmetric key and a hash key, with the symmetric key and the hash key being encrypted.

Further, the secure file is preferably any one of a print file to be transmitted to a printer, a file to be stored in a storage medium, an e-mail transmission, or a facsimile transmission. That is, the secure file format may be utilized in virtually any environment or application where secure transmission/storage of data files is employed.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts a hardware overview for an environment in which the invention may be implemented.

FIG. 2 depicts a block diagram of software components utilized in practicing the invention.

FIG. 3A depicts a format for a validation code used to validate a printer's public key.

FIG. 3B is a table of algorithm designators.

FIG. 4 depicts a format of request messages used in conjunction with the invention.

FIG. 5A and 5B depict examples of a public key request message, and a key validation request message, respectively.

FIG. 6 depicts cleartext for a public key response.

FIG. 7 is a block diagram depicting a format for a public key response.

FIG. 8 depicts a process for creating a secure file according to the invention.

FIG. 9 is a flowchart of process steps for creating a secure client header according to the invention.

FIG. 10A is block format for a Lead-In portion of a secure client header.

FIG. 10B is a block format for a Public Header portion of a secure client header.

FIG. 10C is a block format for a Private Header portion of a secure client header.

FIG. 10D is a block format for a Routing Header portion of a secure client header.

FIG. 11 is a table of values for an Option Mask portion of the Lead-In.

FIG. 12 is a table of values for a Public Key Algorithm of the Public Header.

FIG. 13 is a table of values for a Public Key Length of the Public Header.

FIG. 14 is a table of values for a Symmetric Key Algorithm portion of the Public Header.

FIG. 15 is a table of values for a Symmetric Key Length portion of the Public Header.

FIG. 16 is a table of values for a Signature Algorithm portion of the Public Header.

FIG. 17 is a table of values for a Signature Key Length portion of the Public Header.

FIG. 18 is a table of values of a Hashing Algorithm portion of the Public Header.

FIG. 19 is a table of values for a Hash Key Length portion of the Public Header.

FIG. 20 is a block format of a numeric PIN.

FIG. 21 is a block format of an alphanumeric PIN.

FIG. 22 is a block format for a data payload portion of the secure file format.

FIG. 23 is a block format for a block descriptor portion of the data payload block.

FIG. 24 is a flowchart of process steps for processing the data payload according to the invention.

FIG. 25 is a block format of PJL-UEL encapsulation of a secure file format for transfer to the NEL.

### DETAILED DESCRIPTION OF THE PREFERRED EMBODIMENTS

The following description of a secure file format will be made with regard to a secure printing system in which print jobs that are submitted to a printer are submitted in the secure file format. However, as will become apparent, the secure file format can be utilized in other applications as well, such as saving files to a storage medium in the secure file format, performing e-mail or facsimile transmissions in the secure file format, etc. Thus, while the focus of the following description will be made with regard to a secure printing system, the invention is not limited to such and can be employed in other aspects as well.

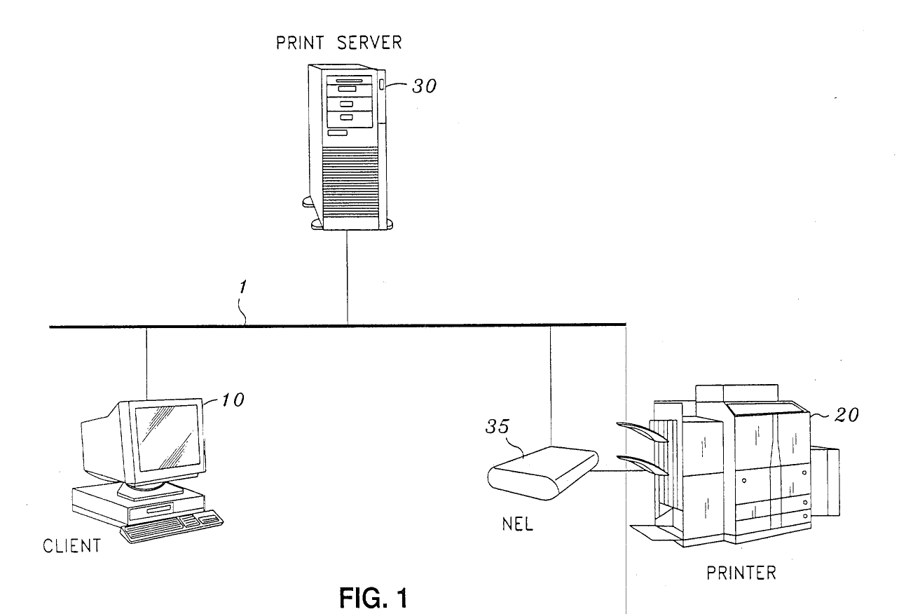

FIG. 1 provides a system view of a computing environment in which the present invention may be implemented. As shown in FIG. 1, the computing environment comprises client computer 10, printer 20, print server 30, NEL device 35 and connection 1. Connection 1 can be a simple local connection between computer 10 and printer 20, such as a serial, USB, firewire, or other such connection. As an alternative, connection 1 may be a network, such as an Ethernet network medium consisting of a bus-type physical architecture. It should be appreciated that connection 1 may also be comprised of another type of network, including the Internet.

Client computer 10 is preferably a personal computer or workstation having a windowing operating system environment such as Microsoft Windows 2000 or Microsoft Windows NT, although other operating systems may also be used. As is typical with PC-type computers, client computer 10 preferably has a display (monitor), keyboard, and a mouse or other type of pointing device so that a user can operate the computer to perform various operations, including submission of a print job to a printer or print server.

Printer 20 communicates with client computer 10 via connection 1 and is preferably a laser or an ink-jet printer which is capable of printing images on a recording medium based on received print data. Preferably, printer 20 is a Canon ImageRunner 5000 (iR5000) printer. Printer 20 may also have a fixed storage medium, which is preferably a fixed disk, but can be a computer memory such as ROM or EEPROM. Printer 20 also includes a connection with NEL 35 such that printer 20 and NEL 35 can communicate with one another. While NEL 35 is shown as being an external stand-alone device, NEL 35 may be incorporated within printer 20 instead, thus forming an embedded device within the printer.

Server 30 may also be connected to connection 1 and is preferably a print server. It should be noted that server 30 is not a necessary component needed for practicing the invention and is merely depicted for a more thorough description. Server 30 preferably comprises a PC-compatible computer having a windowing operating system environment such as Microsoft 2000 server or Microsoft NT server. Of course, server 30 could be any other type of server running other server-type operating systems such as Novell, Unix, Sun Microsystems, etc. Server 30 preferably has a fixed disk which is preferably a large fixed disk for storing numerous files, applications and data. Server 30 can therefore be utilized by other devices on connection 1, such as client computer 10, as a file server or other type of server, such as a print server. Server 30 may also act as a gateway for other devices on connection 1 to access another network such as the Internet.

Also shown in FIG. 1 is NEL device 35. NEL stands for “Net Extend Lite” and the device, although shown as being an external device connected to printer 20, could be embedded within printer 20 instead. Thus, throughout the course of the following description, reference to an “embedded device” refers to the NEL in general. NEL device 35 provides functionality for printer 20 to process encrypted print jobs, as well as other functionalities that are beyond the realm of the present application. With regard to encryption functionality, NEL device 35 includes a mechanism to accumulate entropy (i.e., random data associated with the NEL and printer 20) for use in generating encryption keys, algorithms for generating the encrypting and decrypting the encryption keys, as well as for validating the encryption keys, etc. In this manner, NEL device 35 provides the ability for printer 20 to receive and process encrypted print jobs. A more detailed description of the functionality of NEL device 35 will be provided for below.

Utilizing the computing environment shown in FIG. 1, a user at computer 10 can submit a print job to printer 20 (optionally, via print server 30) using a Windows application. Upon selecting a print option in the Windows application, a print dialog appears and the user can select an option for submitting a secure print job to the printer. The details of the secure file format for a secure print job comprise the present invention and thus, the secure file format will be described in more detail below. However, briefly, the printer driver renders print data for the print job in a printer definition language, encrypts the rendered print data, packages the encrypted print data in the secure file format, and sends the print job to the printer for printing. Part of the process of packaging the print job in a secure file format involves obtaining and validating encryption keys and this process has been described by the inventors herein in co-pending U.S. patent application Ser. No. 10/010,974, filed on Dec. 5, 2001, entitled “Secure Printing With Authenticated Printer Key”, the contents which are hereby incorporated by reference as if set forth in full herein. The secure print job, having been submitted to the printer, is received by the NEL, whereby the NEL decrypts the print job and passes cleartext of the print job to the printer for printout.

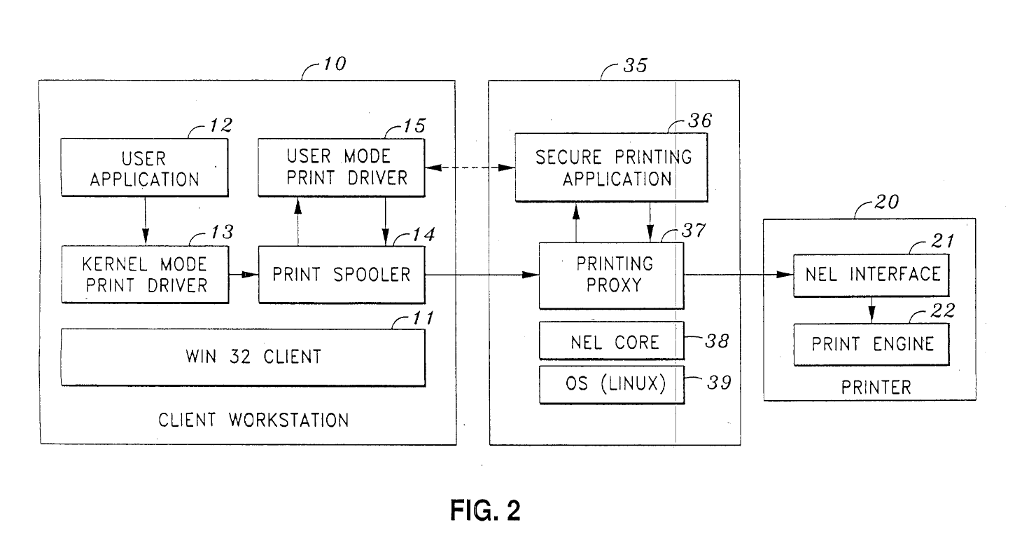

FIG. 2 provides an overview of various software components utilized in practicing the invention. The components depicted in FIG. 2 relate to the use of a Windows operating system, but it can be appreciated that the invention can be implemented in any of various other environments instead and therefore, the invention is not limited to use with the Windows software components depicted in FIG. 2. As seen in FIG. 2, client workstation 10, which as described above, is preferably a PC-compatible workstation running a Windows operating system, includes Win 32 client 11, kernel mode print driver 13 and print spooler 14. Also included within client workstation 10 is at least one user application 12, which may be, for example, a word processing application such as Microsoft Word or Corel WordPerfect, a graphics application such as Microsoft Powerpoint, MGI Photosuite, etc., or any other type of application program for which a print job can be submitted for printing. As is well known in the art, the application program is installed by a user and is preferably stored in a hard disk (not shown) of client workstation 10.

Client workstation 10 is also seen to include User Mode Print Driver 15, which for the present invention, is preferably a Canon secure printer driver installed in client workstation 10 for a Canon printer, such as an ImageRunner 5000 series printer. That is, the client-resident portion of a secure printing software is preferably implemented in the printer driver, using a Common Core Driver (CCD) architecture with Secure Print specific features being implemented in an associated user-mode printer driver. The secure file format of the present invention is preferably generated by User Mode Print Driver 15 and the details of such will be provided below.

The client software also preferably uses a Windows Cryptographic Application Programming Interface (CAPI), where possible. CAPI is a product available with Microsoft Windows operating systems. Note that differences exist between the availability of certain CAPI features among the different Windows operating systems and therefore, the client software should be implemented such that compatibility is ensured on all stated OS platforms. The cryptographic algorithms and functions utilized on the Windows client are preferably RC4 (“Ron's Code #4” for symmetric key encryption/decryption), RSA (“Rivest, Shamir and Adelman”, an asymmetric public key encryption algorithm), using PKCS #1 (Public Key Cryptography Standard) version 1.5 (asymmetric key encryption/decryption; digital signatures/verification), HMAC (Hashing Message Authentication Code), SHA-1 (Secure Hash Algorithm), and a Random Data Source (for generation of symmetric keys).

NEL 35 is seen to include operating system (OS) 39 and NEL Core software 38, which provide NEL 35 with the ability to communicate over the network and to preform various operational functions. As seen in FIG. 2, operating system 39 is preferably Linux, although it can be appreciated that other types of operating systems could also be used. A Secure Printing Application (SP) 36 is also included in NEL 35. One function of SP application 36 is to provide cryptographic functionality for NEL 35, such as generation of cryptographic keys, decryption of print jobs, etc., and makes use of the following cryptographic algorithms and functions: RC4 (symmetric key encryption/decryption), RSA, using PKCS #1, version 1.5 (asymmetric key encryption/decryption; digital signatures/verification), HMAC (message authentication code), SHA-1 (hashing algorithm), and a Random Data Source (for local generation of asymmetric key pairs). NEL 35 also includes Printing Proxy 37 (which may be, for example, an LPR proxy for UNIX or Windows applications, or a Windows proxy for Windows applications) for communicating with print spooler 14 of client workstation 10 (or a print spooler contained in print server 30), and for communicating with printer 20.

Printer 20 is seen to include NEL interface 21 for communication with NEL 35, and print engine 22. Of course, printer 20 could be virtually any network printer that can receive print jobs over a network, but in a preferred embodiment of the invention, printer 20 is a Canon ImageRunner 5000 series printer. It should be noted that, while NEL 35 is depicted as a separate device connected to the network, with the device being external to printer 20, NEL 35 could be fully implemented within printer 20 instead. In this case, NEL 35 within printer 20 may be referred to as an embedded device (i.e., the device being embedded within the printer), or the functionality of the NEL could be implemented in firmware within printer 20 instead. However, as seen in FIGS. 1 and 2, NEL 35 is depicted as an external (stand alone) device which can be connected to an existing printer that does not have an embedded device. Thus, while the description that follows may refer to the external device NEL 35, it is to be understood that reference to an embedded device is to the NEL in general.

In utilizing the secure file format of the present invention, encryption keys for the printer are required. The encryption keys are preferably a private/public keypair for the printer. The printer's keypair is preferably generated within NEL 35 by SP application 36, although the keypair may also be generated outside of NEL 35 and installed in NEL 35 during the manufacturing process. The printer's private key is maintained within NEL 35 and is not to be exposed outside the NEL. The NEL's public key is accessible via the network, as described below, by using a Secure Printer Management Protocol, which will also be described below. In addition to generating the private/public keypair in NEL 35, SP application 36 also preferably performs a hashing algorithm on the printer's public key using a SHA-1 hash algorithm. The hash of the printer's public key is also accessible, in human-readable format, as a field in a test page, which is initiated by user input from a control panel on the printer. Entropy for use in generating the printer's keypair within NEL 35 is preferably obtained from various sources of physically random data.

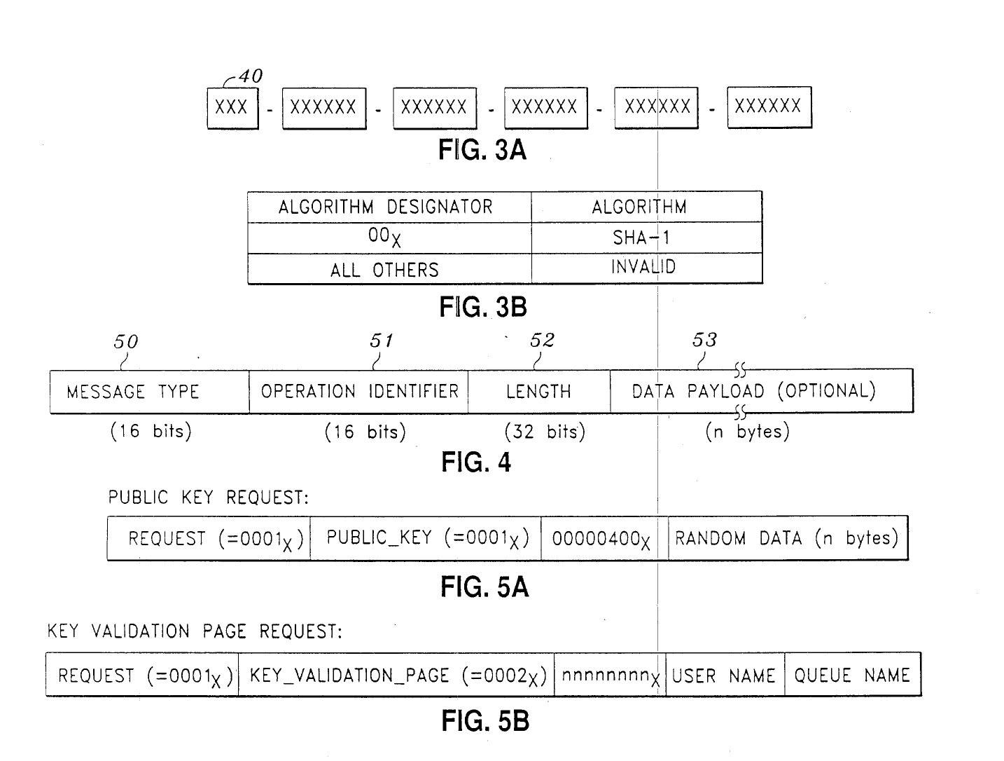

During installation and configuration of the printer driver on the client, the client configuration software obtains the printer's public key directly from the printer, using a Secure Printer Management Protocol, as defined below. In order to ensure that the key has been reliably delivered to the client driver, a key verification step is used during installation. In performing the verification, the user obtains a test page directly from the printer, which includes the SHA-1 hash of the printer's public key. The user then enters the hash value that was obtained in this manner into a configuration dialog provided by the printer driver. The printer driver's setup utility computes a hash on the key that it obtained directly from the printer and compares the result to the hash value that was obtained by the user from the printer's test page. If the hash values are identical, the printer's public key has been verified and is permanently installed in the client system. After verification, the key is digitally signed by the driver, using native Windows features, to prevent tampering. If the hash value calculated over the received public key does not match the hash value displayed on the test page and entered by the user, an error message is presented to the user and the installation process fails. If such a failure occurs, the printer's public key is not installed into the client system and the printer driver will not allow secure print jobs to be sent to the printer. Ideally, printing of the validation code should be initiated locally at the printer, with the printer in the offline state. However, the validation code may be generated by the NEL, with the NEL then generating a test page containing the validation code. This validation code page is then transmitted to the printer, using a local network interface between the NEL and the printer as, for example, LPR data. In order to provide flexibility in the choice of hash algorithms, a single-byte field (referred to as an “Algorithm Designator”), indicating the hash algorithm in use, is preferably prepended to the actual hash result. Using this implementation, when the user enters the value obtained from the test page into the client's installation dialog, the algorithm in use will be known to the client. The actual key validation code is created by combining the Algorithm Designator with the hash value, and then applying an alphanumeric transform to the result. The printed values on the test page are then displayed as a series of alphanumeric characters, as shown in FIGS. 3A and 3B, with the Algorithm Designator corresponding to box 40.

The validity of the key may also be ensured using a public key infrastructure (PKI). In this implementation, the printer's key is delivered within a cryptographic certificate, signed by a trusted certification authority. In that case, the installation program verifies the integrity of the key by verifying the signature and other information contained in the certificate. In the absence of a functional public key infrastructure (PKI), however, the implementation described above is preferred. Further enhancements to the key distribution process may also include administrative tools that allow the printer's public key and hash to be installed into the client driver from a floppy disk or a secure website. Such tools may improve the ease of installation, but can also pose added security risks.

Once the printer's public key has been properly installed in the client workstation, the user is able to submit a secure print job for printing. When a user selects an option for a secure print job, another encryption key (symmetric key) is generated by the user mode print driver. As is known in the art, symmetric keys are generated using what is referred to as a source of entropy (i.e., randomly generated data). In the present invention, entropy for use in generating the symmetric key is preferably obtained using standard Windows Cryptographic Application Programming Interface (CAPI) methods. The symmetric key obtained in this manner is preferably only used for a single print job, after which it is destroyed. All remnants of the symmetric key are destroyed by overwriting, such that the symmetric key cannot be recovered from the client system by any means. Remnants of the key, as well as any cleartext data buffers in system memory, are overwritten with a pattern, using at least one pass. Remnants of cleartext data buffers that exist on hard disk are overwritten using a technique corresponding to DOD 5220.22-M, “clear” level, or better. It should be noted that another possible source of unexpected leakage is the system's virtual memory mechanism. Some or all of an application's memory can be unexpectedly swapped out and stored in a swap file at any time. Therefore, techniques are preferably used that temporarily store sensitive material, including keys, in an area of memory that cannot be swapped.

As stated above, during setup and configuration, the client communicates with the NEL, for the purpose of obtaining the NEL's (printer's) public key. This communication makes use of a Secure Printer Management Protocol (SPMP). In this SPMP, requests are communicated between the client and the NEL using standard TCP/IP protocol. The request message format is shown in FIG. 4, which consists of a series of fields. As seen in FIG. 4, the request consists of a message type field 50, an operation identifier field 51, a length field 52 and a data payload field 53. The message type field 50 is preferably a 16-bit field which denotes the basic message type that is being sent. Some possible message types are (00ₓ=Invalid, 01ₓ=Request). Operation identifier field 51 is preferably a 16-bit field which denotes the specific operation that is being performed. Possible types of operation identifiers are (00ₓ=Invalid, 01ₓ=PUBLIC_KEY, 02ₓ=KEY_VALIDATION_PAGE). Data length field 52 contains the length, in bytes, of the data payload contained in data payload field 53. Data payload field 53 contains data that is transferred with the request. For instance, the data may comprise randomly generated data that can be used as a source of entropy by the receiving device (NEL) to generate encryption keys. FIGS. 5A and 5B depict examples of a public key request message and a key validation page request, respectively. Note that the example of FIG. 5A shows a request for the printer's public key, accompanied by a block of random data. The accompanying random data may be useful for improving the quality of NEL-based generation of cryptographic keys. In other words, the random data included with the request could be used as a source of entropy by the NEL in generating the printer's keypair. In order to ensure the integrity of keys generated with the use of this random data however, the initial key request is preferably performed by an administrator, over a trusted local network segment. It should be noted that the request for the NEL's public key may be transmitted from the client to the NEL in plaintext with no encryption required. Likewise, the NEL may return its public key in plaintext format. The example of FIG. 5B is used to cause the printing of a key validation page, containing a human-readable validation string, derived from a hash of the printer's public key.

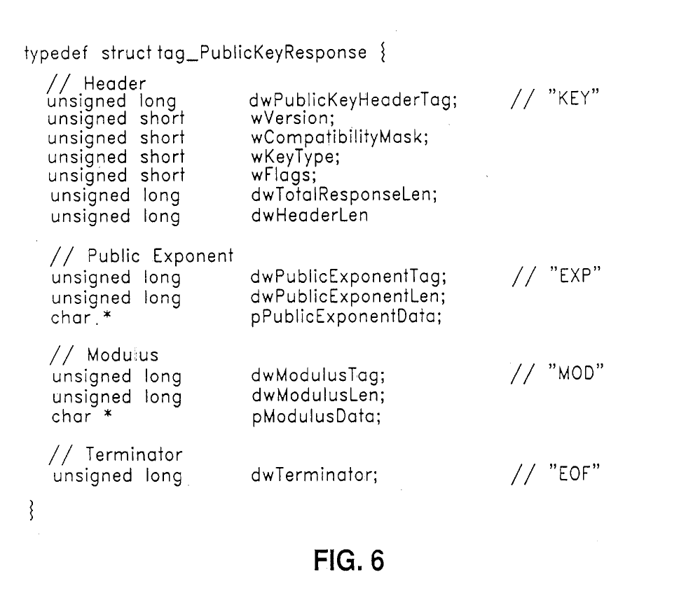

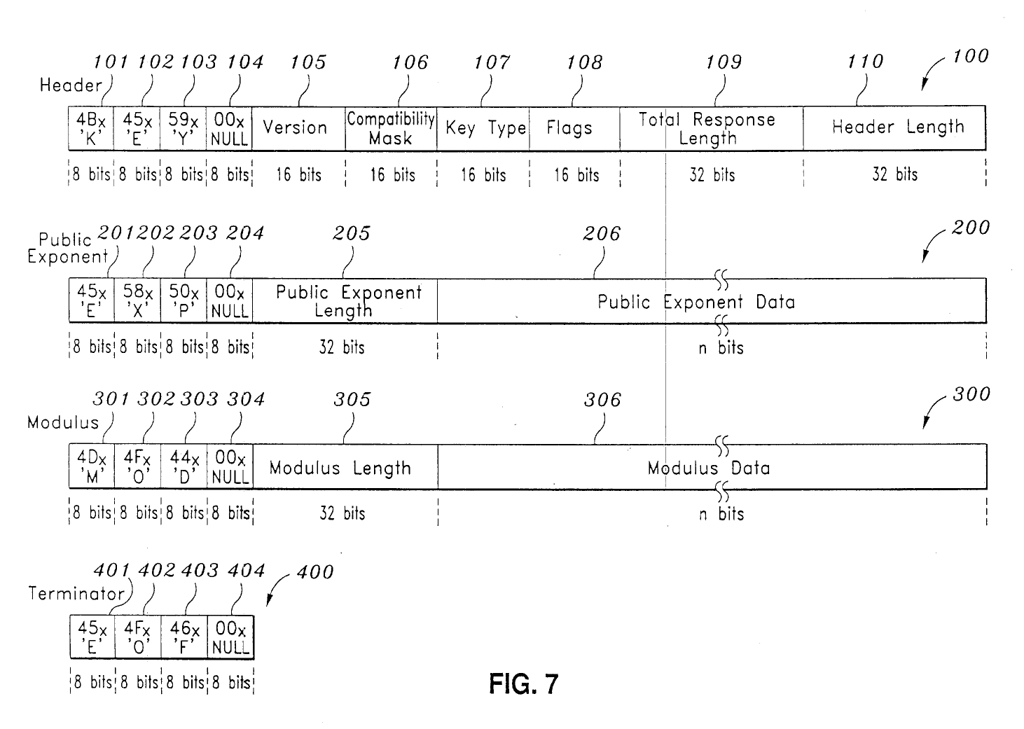

Referring to FIGS. 6 and 7 for the public key response, FIG. 6 depicts source code (i.e., cleartext) for a public key response transmitted from NEL 35 to client workstation 10, while FIG. 7 depicts a block diagram of the format of the public key response. As seen in FIG. 7, the response includes four portions: header 100, public exponent 200, modulus 300, and terminator 400. It should be noted that, while FIG. 7 shows each portion of the response as being separate blocks, the response is actually a single message, with each block appended to one another. Each of the four portions of the public key response will now be described in more detail.

As shown in FIG. 7, header 100 is a group of fields that contain general information, such as the public key algorithm used and other formatting information. The first four bytes (101-104) contain a Public Key Response Identifier, 4Bₓ, 45ₓ, 59ₓ, 00ₓ (“KEY”), identifying the formatting as a Public Key Response. Version field 105 contains a 16-bit value identifying the version of the Public Key Response format used to transfer the key. Compatibility Mask field 106 contains a 16-bit value identifying the minimum version of the Public Key Response format that a recipient must support to be able to recover the data from the message. For example, if the Version field contains “3” and the Compatibility Mask field contains “2,” the file was formatted in Public Key Response format version 3, but it is compatible with, and can be recovered by clients that support, version 2 or greater. A value of zero in this field indicates that the recipient version must be at least as high as the version indicated in the Version field. Key Type field 107 contains a 16-bit value identifying the algorithm that is being used. Flags field 108 contains optional flags. Total Response Length 109 is a 32-bit-field that contains the length of the entire Public Key Response message, in bytes, from the beginning of the Public Key Identifier (101) through the end of the Check Value field (404). Header Length 110 is a 32-bit field that contains the length of the header section of the Public Key Response message, in bytes, from the beginning of the Public Key Identifier (101) through the end of the Header Length field 109. This value can be used to locate the beginning of the Public Exponent portion 200.

The Public Exponent 200 is a group of fields that are used to support the transfer of the RSA public exponent. It includes the public exponent itself, and other formatting information. As seen in FIG. 7, the public exponent 200 includes a Public Exponent Identifier, which comprises the first four bytes (201-204), 45ₓ, 58ₓ 50ₓ, 00ₓ (“EXP”), identifying the beginning of the Public Exponent block. Public Exponent Length 205 is a 32-bit field that contains the length of the Public Exponent section of the Public Key Response message, in bytes, from the beginning of the Public Exponent Identifier (201) through the end of the Public Exponent data field 206. This value can be used to locate the beginning of the Modulus block 300. The Public Exponent Data 206 is a variable-length field that contains the RSA public exponent. The exponent is constructed as a block of bytes, in network order, most-significant-bit first.

Modulus 300 is a group of fields that are used to support the transfer of the RSA modulus. It includes the RSA modulus itself, and other formatting information. The first four bytes (301-304) contain the Modulus Identifier, 4Dₓ, 4Fₓ 44ₓ, 00ₓ (“MOD”), identifying the beginning of the Modulus block. Modulus Length 305 is a 32-bit field that contains the length of the Modulus section of the Public Key Response message, in bytes, from the beginning of the Modulus Identifier (301) through the end of the Modulus Data field 306. Modulus Data 306 is a variable-length field that contains the RSA modulus.

Finally, Terminator 400 is a field that is used to identify the end of the Public Key Response. The terminator value consists of a fixed ASCII identifier, “EOF”, immediately following the Modulus Data 306. The Terminator comprises four bytes (401-404) that contain the Terminator, 45ₓ, 4Fₓ, 46ₓ, 00ₓ (“EOF”), identifying the end of the Public Key Response.

Thus, the client, having received the public key response in the foregoing format, is provided with various information needed to generate a secure file in the secure file format of the present invention, a detailed description of which will now be provided. Briefly, however, a secure file, and as will be described below, a secure file for a print job, is generated by generating a secure client header and appending encrypted print data thereto. As an enhancement, the encrypted print data appended to the secure client header may be processed further for additional security by performing integrity checks in a chaining fashion on the encrypted print data.

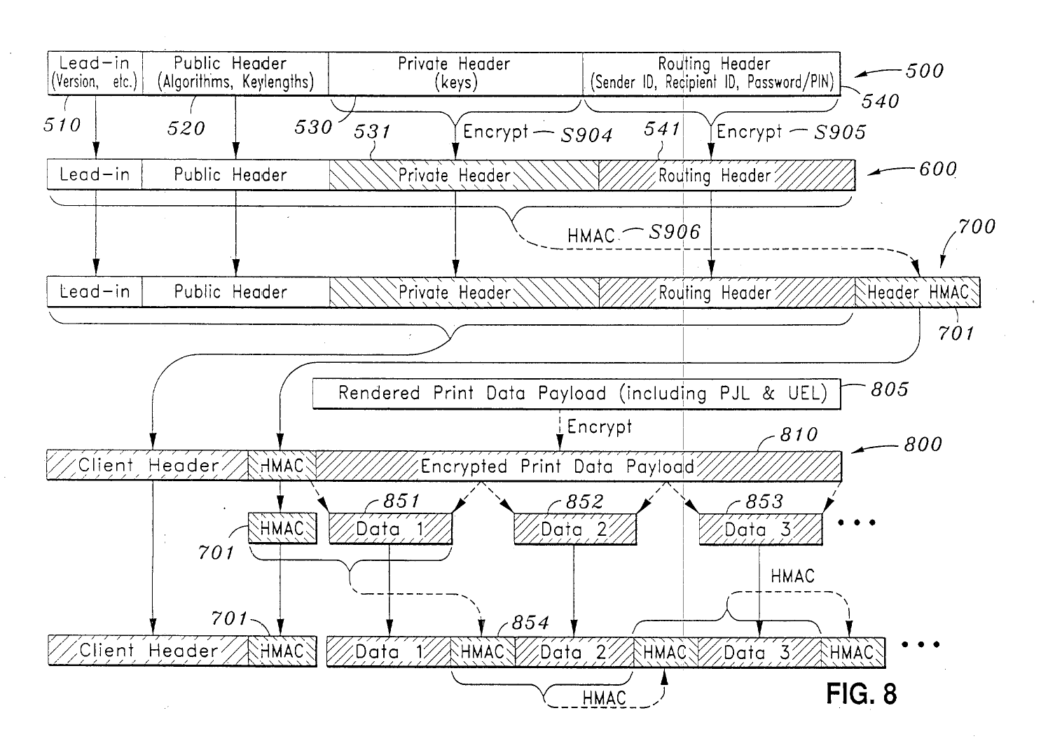

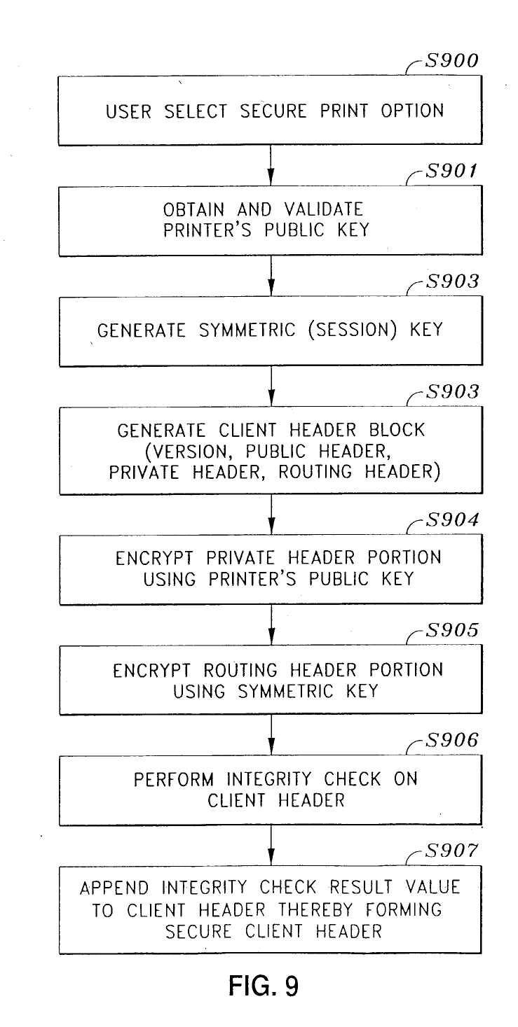

Referring now to FIGS. 8 and 9, a process of generating a secure client header will be described. It should be noted that FIG. 8 depicts a block diagram of various portions of a secure file format according to the invention, including the foregoing enhancement of the print data, while FIG. 9 focuses on the process steps for generating the secure client header. As seen in FIG. 9, when a user selects an option to submit a secure print job (step S900) from, for example, a print option in an application program of client computer 10, the print driver obtains the printer's public key (step S901) and preferably (although optional) validates the printer's public key. As described above, the printer's public key and a hash value thereof are preferably installed and configured in the print driver of the client computer when the print driver is first installed. In this case, the printer's public key may be obtained from a local storage medium in client computer 10 and a hashing algorithm (such as SHA-1) may be performed on the obtained key. The hash value that results from the foregoing process may then be compared with the hash value stored in the client computer to validate the printer's public key. As an alternative, the print driver may submit a request to the printer (or the NEL) to obtain the printer's public key directly from the printer (or the NEL). The printer's public key is then provided to the print driver, where it is validated by performing a hashing algorithm on the received public key and comparing the resultant value with the hash value stored in the client computer. In addition, rather than comparing hash values, the received public key may be directly compared with the stored public key. After having obtained the printer's public key, or simultaneous thereto, the print driver generates a symmetric (session) key (step S902) for use in generating the secure client header. The foregoing process has also been described by the inventors herein in co-pending Application Ser. No. 10/010,974, the contents of which are hereby incorporated by reference, and the process described therein could also be applied in the present invention.

In generating the secure client header, the user mode print driver first generates a client header (step S903), which as seen in FIG. 8, client header 500 comprises a lead-in block 510, a public header block 520, a private header block 530 and a routing header block 540. The contents of each of blocks 510, 520, 530, and 540 will be described in more detail below. It should be noted that routing header 540 is optional and may be included within client header 500 where a print job is designated as being destined to a particular recipient, or where the identity of the sender or the recipient is desired. That is, if the print job requires some type of recipient authentication before the print job is to be printed out, or if it is necessary to identify the sender of the print job, routing header 540 may be included, but otherwise can be omitted.

Having generated client header 500, the private header portion 530 thereof (or as will be described below, at least some portion of the private header) is encrypted using the printer's public key (step S904), thereby resulting in encrypted private header 531. Additionally, routing header 540 (or at least some portion thereof) is encrypted using the symmetric (session) key (step S905), thereby resulting in encrypted routing header 541. Thus, once the foregoing encryption processes have been performed, client header 500 is transformed into encrypted client header 600.

Continuing with the process for generating a secure client header, encrypted client header 600 is subjected to an integrity check (step S906). The integrity check performed is preferably a Hashing Message Authentication Code (HMAC) algorithm, although any other type of integrity check could be used instead. The integrity check result value (HMAC value 701) is then appended to the encrypted client header 600 (step S907), thus transforming header 600 into secure client header 700.

To complete one embodiment of a secure file format according to the invention, print data payload 805 is encrypted with the symmetric (session) key, thereby resulting in encrypted print data payload 810. The encrypted print data payload 810 is appended to the secure client header 700 to form the secure print file 800. The secure print file 800 is then transmitted to the NEL via connection 1. As briefly stated above, an enhancement may be performed on the encrypted print data payload 800 and this process will be described in more detail below. However, first, a more detailed description of the contents of client header 500, and in particular, the contents of lead-in block 510, public header block 520, private header block 530, and routing header block 540 will be provided.

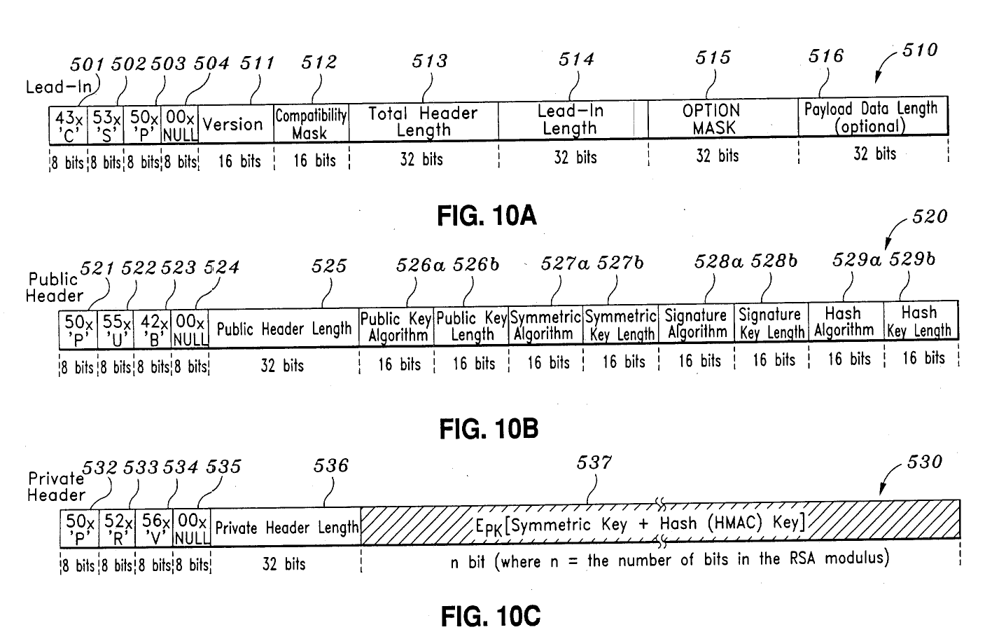

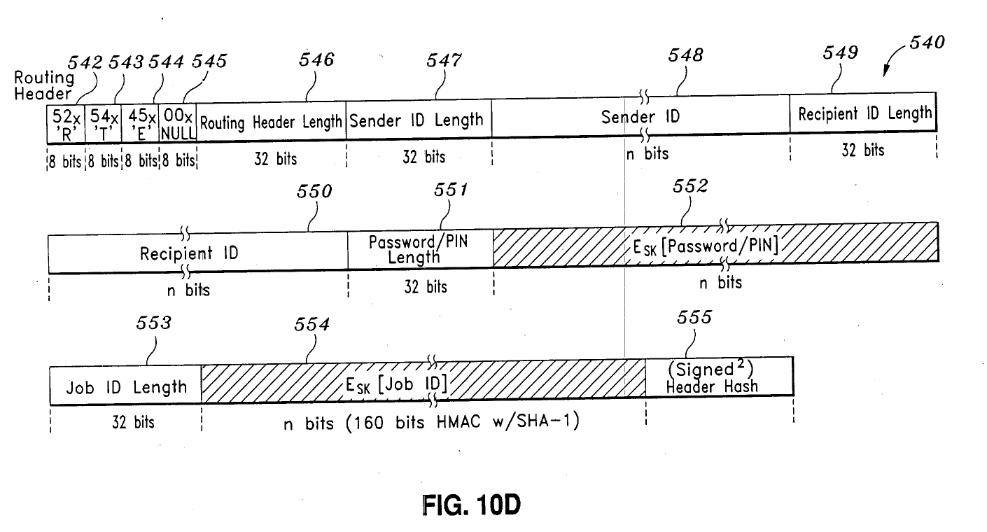

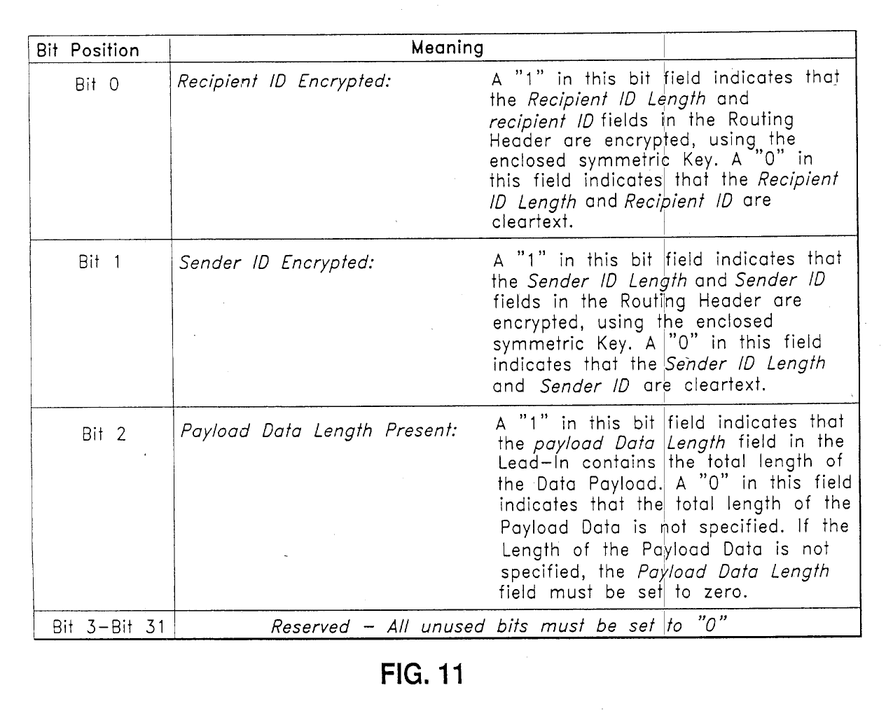

Referring now to FIG. 10A, Lead-In block 510 is a group of fields that contain general information identifying the file as a Secure Print format and providing necessary information such as the version of Secure Print file format used and other formatting information. Lead-In block 510 is seen to include a Secure Print File Identifier (blocks 501 to 504). The first four bytes (501-504) contain the Secure Print File Identifier, 0x43, 0x53 0x50, 0x00 (“CSP”), identifying the formatting as a Secure Print file format. Version block 511 is a field that contains a 16-bit value identifying the version of Secure Print format used to prepare this file. Compatibility Mask 512 is a field that contains a 16-bit value identifying the minimum version of the Secure Print format that a recipient must support to be able to recover the data from this file. For example, if the Version field contains “3” and the Compatibility Mask field contains “2,” the file was formatted in Secure Print format version 3, but it is compatible with, and can be recovered by clients that support version 2 or greater. A value of zero in this field indicates that the recipient version must be at least as high as the version indicated in the version field. Total Header Length 513 is a 32-bit field that contains the length of the entire Secure Print header, in bytes, from the beginning of the Secure Print File Identifier (501) through the end of the header hash (reference numeral 555 of FIG. 10C). This value can be used to locate the beginning of the Payload Data. Lead-In Length 514 is a 32-bit field that contains the length of the lead-in section of the Secure Print header, in bytes, from the beginning of the Secure Print File Identifier (501) through the end of Payload Data Length field 516. This value can be used to locate the beginning of the Public Header. Option Mask 515 contains a 32-bit field that identifies any options that were selected when this file was generated. Each bit (or bit field) is used to select a separate option. The contents of this field inform the receiving device (printer) which options were selected when the file was constructed by the sending client. Some values that may be used in the options mask field are shown in FIG. 11. Payload Data Length 516 is a field that contains an optional 32-bit value that describes the total size of the Payload Data section of the Secure Print file. It contains the total number of bytes, beginning with the Payload Data Identifier (44ₓ, 41ₓ, 54ₓ, 00ₓ) and ending with the End of File Identifier (45ₓ, 4Fₓ, 46ₓ, 00ₓ), inclusive (these will be described in more detail below). This field is optional. Where it is possible for the sending client to do so, this field can be used to provide size information to the receiving entity (such as a printer). Printer drivers that are not aware of the total data payload size at the time the header is transmitted, and thus cannot make use of this field, must set all the bits in this field to zero and must also set the Payload Data Length Present bit to “0.”

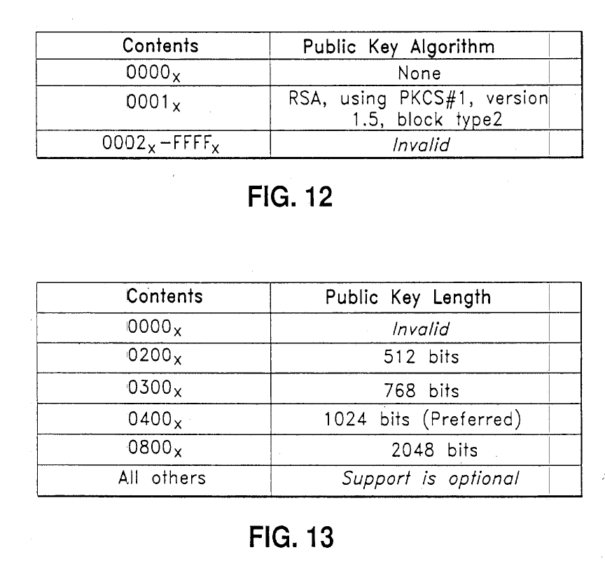

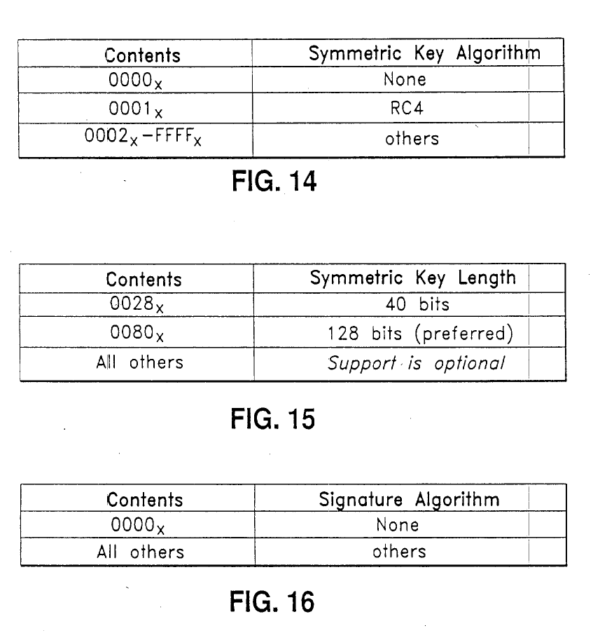

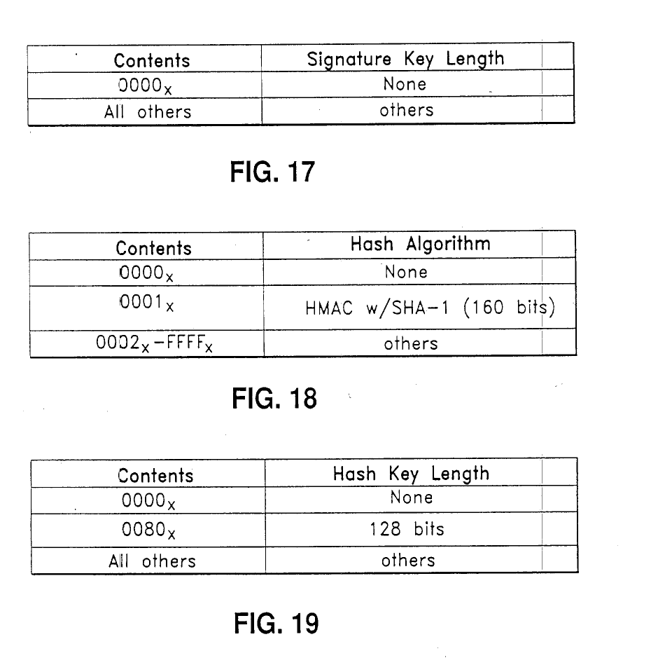

FIG. 10B depicts a block format for the contents of Public Header 520. The Public Header is a group of fields that contain information identifying the encryption algorithms and key lengths used to prepare the Secure Print file. The first four bytes (521-524) contain the Public Header Identifier, (50ₓ, 55ₓ, 42ₓ, 00ₓ) (“PUB”), identifying the beginning of the Public Header. This field is not required for function purposes, but is included to facilitate manual examination of a Secure Print file. Thus, this field could be eliminated. Public Header Length 525 is a 32-bit field that contains the length of the Public Header, in bytes, from the beginning of the Public Header Identifier (521) through the end of the Hash Length field (529b). This value can be used to locate the beginning of the Private Header. Public Key Algorithm 526a is a field that contains a binary value, which identifies the public-key algorithm used to process the public-key-encrypted fields that follow. Some values that may be used for this field are shown in FIG. 12. Public Key Length 526b is a field that contains the length, in bits, of the public key used to process the public-key-encrypted fields that follow. Support is preferable for 1024-bit RSA public keys and some values for this field are shown in FIG. 13. Symmetric Key Algorithm 527a is a field that contains a binary value, which identifies the symmetric-key algorithm used to perform bulk encryption of the data and other fields. Some values for this field are shown in FIG. 14. Symmetric Key Length 527b is a field that contains the length, in bits, of the key used to perform bulk encryption of the data and other fields. Support is preferable for 128-bit RC4 symmetric keys and some values that may be used in this field are shown in FIG. 15. Signature Algorithm 528a is a field that contains a binary value that identifies the digital signature algorithm used to sign the hash values. Some examples of values for this field are shown in FIG. 16. Signature Key Length 528b is a field that contains the length, in bits, of the key used to apply a digital signature to the signed hash fields. Some example values for this field are shown in FIG. 17. Hash Algorithm 529a is a field that contains a binary value which identifies the symmetric-key algorithm used to perform bulk encryption of the data and other fields. Some example values for this field are shown in FIG. 18. Hash Key Length 529b is a field that contains the length, in bits, of the hash key. A hash key is required only if keyed hashes (such as HMAC) are employed. Some example values for this field are shown in FIG. 19.

FIG. 10C depicts a block diagram of a format for Private Header 530. The Private Header is a group of fields that contain secret information required to decrypt a Secure Print file and to allow a user to authenticate himself at the printer. The first four bytes (532-525) contain a Private Header Identifier, (50ₓ, 52ₓ, 56ₓ, 00ₓ) (“PRV”), identifying the beginning of the Private Header. This field is not required for function purposes, but may be included to facilitate manual examination of a Secure Print file. Private Header Length 536 is a 32-bit field that contains the length of the Private Header, in bytes, from the beginning of the Private Header Identifier (532) through the end of the RSA-Encrypted Key block 537, containing the symmetric key and the hash key. This value can be used to locate the beginning of the Routing Header. RSA-Encrypted Key block 537 contains both the symmetric key and the hash key, which have been concatenated and encrypted, using the public key of the target printer. Recall from above that at least a portion of Private Header 530 is encrypted to form encrypted private header 531 and the foregoing encryption of the symmetric key and hash key with the printer's public key comprise such encryption. The length of this block is equal to the length of the RSA modulus, in bytes. The length of the cleartext key values (before encryption) is specified in the Symmetric Key Length (527b) and Hash Key Length (529b) fields of the Public Header, respectively. A description of the cleartext versions of these two keys (before encryption) is as follows.

The “Symmetric Key” field is the symmetric key that is used to encrypt the data payload. This same key is used to decrypt and recover the original plaintext data. The length of the symmetric key is contained in the Symmetric Key Length (527b) field of the Public Header. The “Hash Key” field is the HMAC or other hash key that is used to calculate the message authentication code (MAC) that follows each block of the encrypted payload data (this process will be described in more detail below). This same key is used by the receiving entity to validate the data in each block. The length of the hash key is contained in the Hash Key Length (529b) field of the Public Header.

Referring now to FIG. 10D, Routing Header 540 is a group of fields that contain information identifying the sender and the recipient of the Secure Print file. The first four bytes (542-545) contain the Routing Header Identifier, (52ₓ, 54ₓ, 45ₓ, 00ₓ) (“RTE”), identifying the beginning of the Routing Header. This field is not required for function purposes, but may be included to facilitate manual examination of a Secure Print file. Routing Header Length 546 is a 32-bit field that contains the length of the Routing Header, in bytes, from the beginning of the Routing Header Identifier (542) through the end of the Header Hash field (555). This value can be used to locate beginning of the Payload Data. Sender ID Length 547 is a 32-bit field that contains the length of the Sender ID field 548, in bytes. If the Sender ID Encrypted bit in the Option Mask field is set to “1,” this field is encrypted with the symmetric (session) key. Sender ID field 548 contains identifying information that can be used to uniquely identify the sender of the Secure Print data, including any padding bytes. Depending on the application, this field may contain a relatively short ASCII or Unicode identifier, such as a user's login name, a numeric user ID or even a more lengthy, fully-qualified user name. If the Sender ID Encrypted bit in the Option Mask field is set to “1,” this field is encrypted with the symmetric (session) key.

Recipient ID Length 549 is a 32-bit field that contains the length of the Recipient ID field 550, in bytes, including any padding bytes. If the Recipient ID Encrypted bit in the Option Mask field is set to “1,” this field is encrypted with the symmetric (session) key. Recipient ID field 550 contains identifying information that can be used to uniquely identify the intended recipient of the Secure Print data. Depending on the application, this field may contain a relatively short ASCII identifier, such as a user's login name, a numeric user ID, or even a more lengthy, fully-qualified user name or even a signed certificate. Note that it may be desirable to maintain the sender information in cleartext, so that a recipient can obtain a signature-verification key for the sender, without having to perform a costly RSA decryption to obtain the symmetric key and then use the symmetric key to obtain the user information. If the Recipient ID Encrypted bit in the Option Mask field is set to “1,” this field is encrypted with the symmetric key.

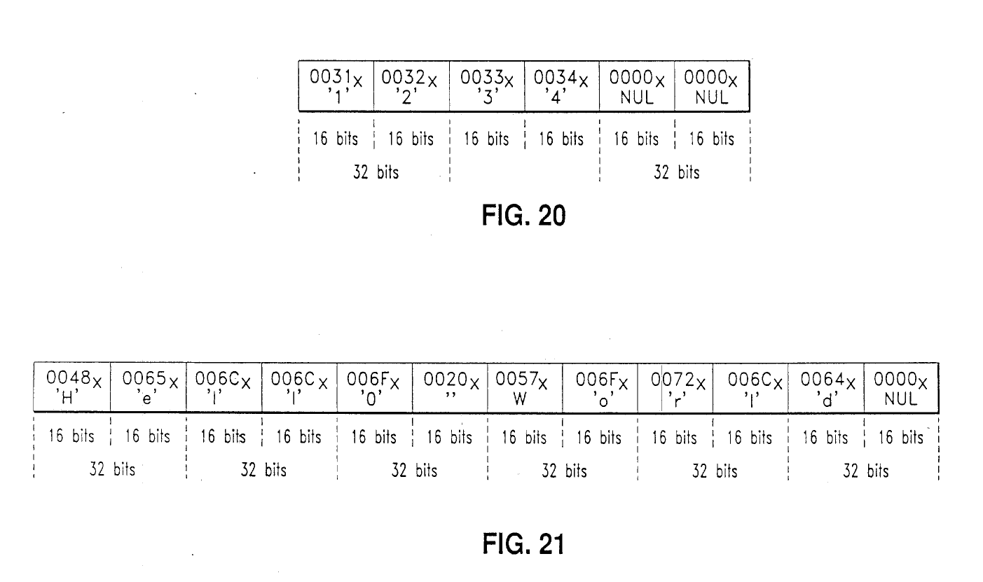

Password/PIN Length 551 is a 32-bit field that contains the length of the Password/PIN field 552, in bytes, including any padding bytes. This field is preferably, although optionally, encrypted with the symmetric key. Password /PIN field 552 contains a password or PIN (Personal Identification Number), which is used to authenticate a user who attempts to release a Secure Print job for printing. It will typically be entered by the user on a keypad at the printer. In this regard, it is desirable to provide the capability to use an alphanumeric password on the printer, where those characters can be supported by the user interface on the printer. It is also desirable to support extended (non-ASCII) characters for international applications. For that reason, the PIN, before encrypting, is stored in a series of 32-bit fields, using two bytes to represent each digit as a UCS-2 (16-bit) Unicode value. The data is stored in network order. Unused bytes are filled with Unicode null (NUL) characters. For example, a cleartext PIN value of “1234” (before encryption) may be constructed as shown in FIG. 20. For use with printers that can support alphanumeric passwords, a case-sensitive password (or PIN), before encrypting, may be stored as a null-terminated Unicode string. For example, a cleartext password value of “Hello World” (before encryption) may be constructed as shown in FIG. 21. In order to accommodate a Password/PIN field of variable length, the length of the password is indicated in the Offset to Key field that precedes the Password/PIN. The total length of the password field, including the terminating NULL and any additional padding bytes, should preferably be a multiple of 32 bits. If a password is used that does not fall exactly on a 32-byte boundary, it should be padded with extra nulls to fill out the remaining 32 bits. The “Password/PIN” field is preferably encrypted, using the randomly-generated symmetric key. This field is preferably always encrypted and this encryption constitutes the encryption of step S905 that transforms routing header 540 into encrypted routing header 541.

Job ID Length 553 is a 32-bit field that contains the length of the Job ID field 554, in bytes, including any padding bytes. This field is optionally encrypted using the symmetric key. Job ID field 554 contains the name of the printed document or other information used to identify the job in the printer's queue. This field is preferably encrypted using the symmetric key, and like the encryption of field 552, constitutes the encryption that transforms routing header 540 into encrypted routing header 541.

Signed Header Hash 555, while shown in FIG. 10D, is not part of the routing header, but actually represents integrity check value 701 shown in FIG. 8. This field contains a hash (or HMAC) of the entire Secure Print header, signed by the sender. The signing key will typically be the RSA private key of the sender, but the use of other signing algorithms, such as the federal Digital Signature Algorithm (DSA), as specified in the federal Digital Signature Standard (DSS) may be used instead. The length of the signing key is contained in the Signature Length field 528b of the Public Header.

Thus, the file format depicted in FIGS. 10A to 10D makes up a secure client header according to the invention. However, as stated above, the routing header is optional and may be included where the print job is targeted for a specific recipient or where the identity of the sender is desired. To complete one embodiment of the secure file format according to the invention, print data is appended to the secure client header and a description of the print data payload will now be provided.

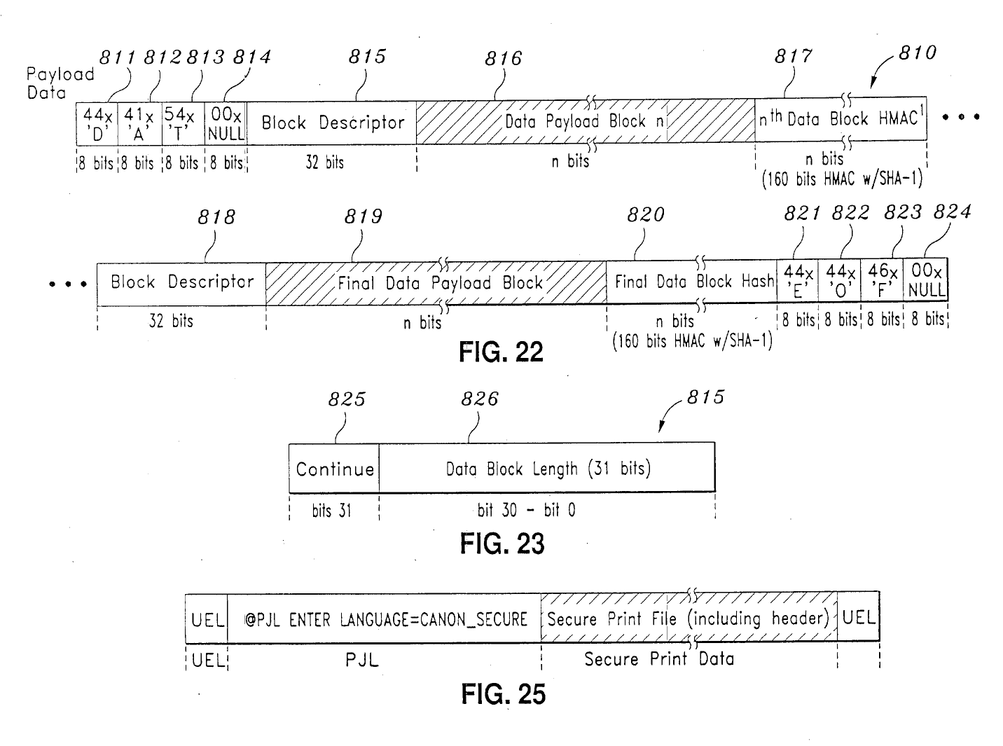

Referring back to FIG. 8, secure file format 800 is seen to include the secure client header 700, with encrypted print data payload 810 appended thereto. The format for the encrypted print data payload 810 is depicted in FIG. 22. As seen in FIG. 22, the first four bytes (811-814) contain a Payload Data Identifier, (44ₓ, 41ₓ, 54ₓ, 00ₓ) (“DAT”), identifying the beginning of the Payload Data. This field is not required for functional purposes, but is included to facilitate manual examination of a Secure Print file.

Block Descriptor 815 is a field that contains a 32-bit block descriptor, which describes the current encrypted data block. A layout of Block Descriptor 815 is shown in FIG. 23. The lower 31 bits (826) of the block descriptor contain the length of the current block, in bytes. Note that this length does not include the block hash that follows the data block itself. The upper bit (825) is defined as “Continue,” and indicates whether or not more data blocks will follow this block. A “1” in this bit indicates that more data blocks will follow, and a “0” in this bit indicates that this is the final data block. It should be noted that the data payload is preferably sectioned into multiple blocks to facilitate processing on devices with limited storage and memory resources. This sectioning is represented in FIG. 8 by data blocks 851, 852, 853, etc. Thus, the Block Descriptor identifies each of the multiple blocks, and as seen in FIG. 22, Block Descriptor 815 represents the first block of the encrypted data payload, and Block Descriptor 819 represents the last block of the encrypted data payload. Of course, additional block descriptors would be included to represent each of any other encrypted data payload blocks. Additionally, if the print data payload is small enough, or if the printing device can handle large data payloads, only one data payload block may be included and it may not be necessary to break-up the data payload into multiple blocks.

The actual data payload is contained in Data Payload block 816 and is preferably encrypted using the symmetric (session) key generated by the client, thus forming the encrypted data payload.

Data Block HMAC 817 is a field that contains an integrity check result (hash) value, and in this case, an HMAC (Hashing Message Authentication Code) value. A hash or HMAC is provided for each block to allow the target device (printer) to determine that errors have occurred before reaching the end of a potentially large file. The use of a keyed hash, such as HMAC, allows the device to immediately determine that a block was damaged or tampered with, allowing the device to immediately terminate the job. The Data Block HMAC 817 is calculated over the previous HMAC (the header HMAC 701 in the case of the first data block, or the previous data block HMAC, in the case of the remaining data blocks), the current Block Descriptor and the ciphertext data for the current data block. A graphical representation of this chaining type of integrity checking is depicted in FIG. 8, wherein, for the first data block 851, an integrity check (HMAC) is run over the secure client header HMAC 701 and the first data block 851 to obtain a hash value 854. It should be noted that reference to data block 851 is merely a generalization and data block 851 includes the data descriptor field and the data payload as described above. The hash value 854 of FIG. 8 is placed in the Payload Data portion of the secure file format as block 817 of FIG. 22. An integrity check (HMAC) is then run for the second data block 852, with the HMAC being run over the previous HMAC (in this case, HMAC 854 of the first data block) and the second data block 852. The process continues in this chain fashion until an integrity check value (HMAC hash) has been obtained for each data block. Thus, in order to cause the final HMAC result to represent the integrity of the entire job, each preceding HMAC is combined with each subsequent data field, such that the last hash is a representation of the entire job.

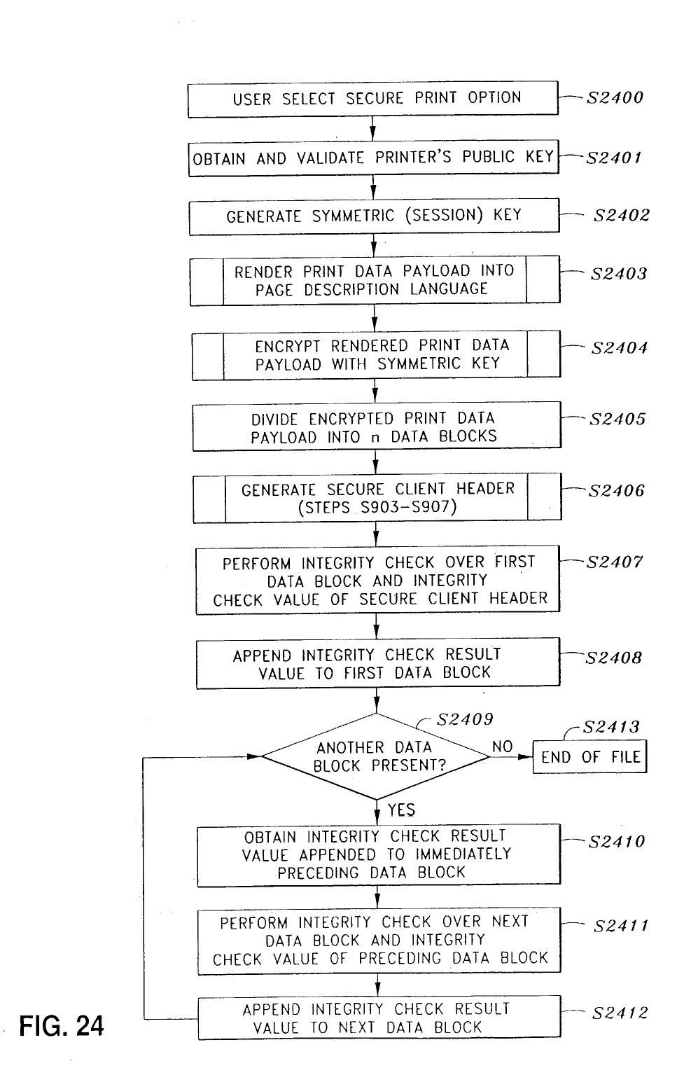

The foregoing process is also depicted in a flowchart of FIG. 24. As shown in FIG. 24, when a user selects an option for a secure print job (S2400), the print driver obtains and validates the printer's public key (S2401) and generates a symmetric key (S2402). The print driver then commences rendering the print job data into a page description language (such as PCL or PostScript) based on the selected printer (S2403). The rendered print data is then encrypted with the symmetric key (S2404), and the encrypted data is divided into a plurality of data blocks (where n represents the number of data blocks). As an alternative, rather than processing the entire job (i.e., rendering the entire print job, encrypting the entire job and then dividing the job into a plurality of blocks), a dynamic approach may used where the print job is dynamically processed in a series of blocks, with each block being rendered, encrypted and, as will be described in more detail below, processed with an HMAC. The print driver also generates the secure client header as previously described with regard to FIG. 9, and in particular, steps S903 to S907. Of course, the secure client header may be generated prior to processing of the data payload and the secure client header transmitted to the printer ahead of the data payload. Once the secure client header is generated, an integrity check (preferably an HMAC) is run over the first of the n data blocks and the integrity check result value appended to the secure client header (S2407). The integrity check result value (HMAC) that results from step S2407 is appended to the first data block and appears in the secure file format as block 817 as described above with regard to FIG. 22. Then, it is determined whether all of the data blocks have been processed (i.e., whether any more of the n data blocks are present) (S2409). If additional data blocks are present, then the integrity check result value appended to the immediately preceding data block is obtained (S2410) and an integrity check (HMAC) is run over the obtained value and the next data block (S2411). The integrity check value that results from step S2411 is appended to the next data block (S2412) and flow returns to step S2409 to determine whether any additional data blocks are present that have not yet been processed. The process continues until all of the data blocks have been processed, at which point the end of file has been reached (S2413).

Thus, having processed the encrypted data payload according to the foregoing, a secure file format can be comprised of, not only the secure client header in conjunction with commonly encrypted payload data (i.e., data merely encrypted with the symmetric key but not divided and hashed), but the secure client header as described above in conjunction with the divided and hashed encrypted data payload.

Finally, the last portion of the secure file is an End-of-File Identifier. This field consists of four bytes (821-824) which comprise the End-of-File Identifier, (45ₓ, 4Fₓ, 46ₓ, 00ₓ) (“EOF”). This is the final field in a Secure Print File, designating the end of the Secure Print job.

While the foregoing described how a secure file format may be generated according to the invention, it can be understood that print data is formatted by a client's printer driver, using a number of successive steps, before it is finally delivered to the printer. First, an application's print data is rendered by the client printer driver in a format that is understood by the printer engine. This is typically done using Postscript, PCL or other printer languages. Next, the driver packages the rendered data in the secure print file format, as described above. This step applies encryption and proprietary headers to the rendered data. Finally, the data is formatted for delivery to the printer, adding fields that describe the printer language that is used and other optional printer control parameters. This latter step may be accomplished using an additional Printer Job Language (PJL) command, paired with a terminating Universal Escape Language (UEL) field. In other words, after the print data is prepared in the secure file format as described above, it may be encapsulated using an additional PJL-UEL command pair, which indicates that it is a secure file. An example format of this packaging is shown in FIG. 25. The NEL recognizes this command and processes the print data such that the plaintext, rendered print data is recovered and printed.

Of course, the invention is not limited to use with secure print jobs submitted to a printer, either directly or via the NEL. Rather, the secure file format of the present invention could be implemented in a number of embodiments other than secure print jobs. For example, rather than submitting a print job to a printer, a user can choose an option to print to a file using a virtual printer. In this case, the print file would be packaged as a secure file as described above, with the secure file then being stored in a designated location. Such a location may be, for example, on a local hard disk of client workstation 10, print server 30, on a removable storage medium such a floppy disk or CD-ROM, or any other storage area. In like manner, the secure file is not limited to a print file that is submitted to a virtual printer, but rather, could be a file that is saved in an application program as a secure file. In this regard, a user may merely select an option in an application program to save a file as a secure file. The software in the client computer packages the file in a secure file format according to the invention and the secure file is saved to a designated location.

The secure file format could also be implemented in facsimile transmissions or e-mail messages. In either of these embodiments, data being transmitted via facsimile or e-mail may be packaged in the secure file format according to the invention, with a device at the receiving end performing the functions of the NEL.

Thus, the secure file format of the present invention could be implemented in virtually any environment where secure transmission of data is involved, and in particular, where data is transmitted via the use of public/private keypairs.

The invention has been described with particular illustrative embodiments. It is to be understood that the invention is not limited to the above-described embodiments and that various changes and modifications may be made by those of ordinary skill in the art without departing from the spirit and scope of the invention.

What is claimed is:

1. A method of creating a secure file comprised of a secure client header and a data block, the method comprising the steps of:
generating the secure client header, comprising the steps of:
forming a client information block comprised of a public information block and a private information block;
encrypting at least a portion of the private information block of the client information block;
performing an integrity check on the client information block to obtain a client information integrity check result value; and
appending the client information integrity check result value to the client information block; and
appending the data block to the secure client header to obtain the secure file.

2. A method according to claim 1, wherein the data block is encrypted prior to being appended to the secure client header.

3. A method according to claim 1, wherein the client information block further comprises a routing information block, and wherein at least a portion of the routing information block is encrypted before the integrity check is performed.

4. A method according to claim 1, wherein the public information block comprises at least one of a public key algorithm, a symmetric key algorithm, a signature key algorithm and a hash algorithm.

5. A method according to claim 1, wherein the private information block comprises at least one of a symmetric key and a hash key, and the symmetric key and the hash key are encrypted in the private information block encrypting step.

6. A method according to claim 3, wherein the routing information block comprises at least one of sender identification information, recipient identification information, a password, and job identification information.

7. A method according to claim 6, wherein at least the password and the job identification information are encrypted.

8. A method according to claim 2 further comprising the steps of:
dividing the encrypted data block into n encrypted data blocks;
performing an integrity check for a first one of the n encrypted data blocks and the client information integrity check result value appended to the client information block so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

9. A method according to claim 1, wherein the secure file is any one of a print file to be transmitted to a printer, a file to be stored in a storage medium, an e-mail transmission, or a facsimile transmission.

10. A method according to claim 1 or claim 8, wherein the integrity check comprises a Hashing Message Authentication Code (HMAC).

11. A file format for a secure file, comprising:
a secure client header comprising:
a client information block comprised of a public information block and a private information block, wherein at least a portion of the private information block is encrypted; and
a client information block integrity check value appended to the client information block, the client information block integrity check value being obtained by performing an integrity check on the client information block; and
a data block appended to ihe secure client header.

12. The file format according to claim 11, wherein the data block is encrypted prior to being appended to the secure client header.

13. The file format according to claim 11, wherein the client information block further comprises a routing information block, and wherein at least a portion of the routing information block is encrypted before the integrity check is performed.

14. The file format according to claim 11, wherein the public information block comprises at least one of a public key algorithm, a symmetric key algorithm, a signature key algorithm and a hash algorithm.

15. The file format according to claim 11, wherein the private information block comprises at least one of a symmetric key and a hash key, and the symmetric key and the hash key are encrypted in the private information block encrypting step.

16. The file format according to claim 13, wherein the routing information block comprises at least one of sender identification information, recipient identification information, a password, and job identification information.

17. The file format according to claim 16, wherein at least the password and the job identification information are encrypted.

18. The file format according to claim 12, wherein the encrypted data block comprises a plurality of encrypted data blocks each appended with its own respective integrity check result value, wherein the plurality of data blocks and their respective integrity check result values are obtained by (a) dividing the encrypted data block into n encrypted data blocks, (b) performing an integrity check on a first one of the n encrypted data blocks and the client information integrity check result value appended to the client information block so as to obtain a first encrypted data block integrity check result value, (c) appending the first encrypted data block integrity check result value to the first encrypted data block, and (d) repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

19. The file format according to claim 11, wherein the secure file is any one of a print file to be transmitted to a printer, a file to be stored in a storage medium, an e-mail transmission, or a facsimile transmission.

20. The file format according to claim 11 or claim 18, wherein the integrity check comprises a Hashing Message Authentication Code (HMAC).

21. Computer-executable process steps for creating a secure file comprised of a secure client header and a data block, the executable process steps comprising the steps of:
generating the secure client header, comprising the steps of:
forming a client information block comprised of a public information block and a private information block;
encrypting at least a portion of the private information block of the client information block;
performing an integrity check onthe client information block to obtain a client information integrity check result value; and
appending the client information integrity check result value to the client information block; and
appending the data block to the secure client header to obtain the secure file.

22. Computer-executable process steps according to claim 22, wherein the data block is encrypted prior to being appended to the secure client header.

23. Computer-executable process steps according to claim 21, wherein the client information block further comprises a routing information block, and wherein at least a portion of the routing information block is encrypted before the integrity check is performed.

24. Computer-executable process steps according to claim 21, wherein the public information block comprises at least one of a public key algorithm, a symmetric key algorithm, a signature key algorithm and a hash algorithm.

25. Computer-executable process steps according to claim 21, wherein the private information block comprises at least one of a symmetric key and a hash key, and the symmetric key and the hash key are encrypted in the private information block encrypting step.

26. Computer-executable process steps according to claim 23, wherein the routing information block comprises at least one of sender identification information, recipient identification information, a password, and job identification information.

27. Computer-executable process steps according to claim 26, wherein at least the password and the job identification information are encrypted.

28. Computer-executable process steps according to claim 22 further comprising the steps of:
dividing the encrypted data block into n encrypted data blocks;
performing an integrity check for a-first one of the n encrypted data blocks and the client information integrity check result value appended to the client information block so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

29. Computer-executable process steps according to claim 21, wherein the secure file is any one of a print file to be transmitted to a printer, a file to be stored in a storage medium, an e-mail transmission, or a facsimile transmission.

30. Computer-executable process steps according to claim 21 or claim 28, wherein the integrity check comprises a Hashing Message Authentication Code (HMAC).

31. A computer-readable medium on which are stored computer-executable process steps for creating a secure file comprised of a secure client header and a data block, the executable process steps comprising the steps of:
generating the secure client header, comprising the steps of:
forming a client information block comprised of a public information block and a private information block;
encrypting at least a portion of the private information block of the client information block;
performing an integrity check on the client information block to obtain a client information integrity check result value; and
appending the client information integrity check result value to the client information block; and
appending the data block to the secure client header to obtain the secure file.

32. A computer-readable medium according to claim 32, wherein the data block is encrypted prior to being appended to the secure client header.

33. A computer-readable medium according to claim 31, wherein the client information block further comprises a routing information block, and wherein at least a portion of the routing information block is encrypted before the integrity check is performed.

34. A computer-readable medium according to claim 31, wherein the public information block comprises at least one of a public key algorithm, a symmetric key algorithm, a signature key algorithm and a hash algorithm.

35. A computer-readable medium according to claim 31, wherein the private information block comprises at least one of a symmetric key and a hash key, and the symmetric key and the hash key are encrypted in the private information block encrypting step.

36. A computer-readable medium according to claim 33, wherein the routing information block comprises at least one of sender identification information, recipient identification information, a password, and job identification information.

37. A computer-readable medium according to claim 36, wherein at least the password and the job identification information are encrypted.

38. A computer-readable medium according to claim 32 further comprising the steps of:
dividing the encrypted data block into n encrypted data blocks;
performing an integrity check for a first one of the n encrypted data blocks and the client information integrity check result value appended to the client information block so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

39. A computer-readable medium according to claim 31, wherein the secure file is any one of a print file to be transmitted to a printer, a file to be stored in a storage medium, an e-mail transmission, or a facsimile transmission.

40. A computer-readable medium according to claim 31 or claim 38, wherein the integrity check comprises a Hashing Message Authentication Code (HMAC).

41. A method of creating a secure file comprised of a client header and a data block, the method comprising the steps of:
generating the client header;
performing an integrity check on the client header so as to obtain a client header integrity check result value;
appending the client header integrity check result value to the client header;
generating the data block;
encrypting the generated data block;
dividing the encrypted data block into n encrypted data blocks;
performing an integrity check on a first one of the n encrypted data blocks and the client header integrity check result value appended to the client header so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

42. A method according to claim 41, wherein the integrity check comprises a Hashing Message Authentication Code (HMAC).

43. A file format for a secure file, comprising:
a client header;
a client header integrity check result value appended to the client header; and
an encrypted data block,
wherein, the encrypted data block comprises a plurality of encrypted data blocks each appended with its own respective integrity check result value, wherein the plurality of data blocks and their respective integrity check result values are obtained by (a) dividing the encrypted data block into n encrypted data blocks, (b) performing an integrity check on a first one of the n encrypted data blocks and the client information integrity check result value appended to the client information block so as to obtain a first encrypted data block integrity check result value, (c) appending the first encrypted data block integrity check result value to the first encrypted data block, and (d) repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

44. A file format according to claim 43, wherein the integrity check comprises a Hashing Message Authentication Code (HMAC).

45. Computer-executable process steps for creating a secure file comprised of a client header and a data block, the executable process steps comprising the steps of:
generating the client header;
performing an integrity check on the client header so as to obtain a client header integrity check result value;
appending the client header integrity check result value to the client header;
generating the data block;
encrypting the generated data block;
dividing the encrypted data block into n encrypted data blocks;
performing an integrity check on a first one of the n encrypted data blocks and the client header integrity check result value appended to the client header so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

46. Computer-executable process steps according to claim 45, wherein the integrity check comprises a Hashing Message Authentication Code (HMAC).

47. A computer-readable medium on which are stored computer-executable process steps for creating a secure file comprised of a client header and a data block, the executable process steps comprising the steps of:
generating the client header;
performing an integrity check on the client header so as to obtain a client header integrity check result value;
appending the client header integrity check result value to the client header;
generating the data block;
encrypting the generated data block;
dividing the encrypted data block into n encrypted data blocks;
performing an integrity check on a first one of the n encrypted data blocks and the client header integrity check result value appended to the client header so as to obtain a first encrypted data block integrity check result value;
appending the first encrypted data block integrity check result value to the first encrypted data block; and
repeatedly performing, for each of the subsequent n encrypted data blocks, an integrity check on the subsequent encrypted data block and an integrity check result value appended to a previous one of the n encrypted data blocks, so as to obtain an integrity check result value for the subsequent encrypted data block, and appending the subsequent integrity check result value to the subsequent encrypted data block.

48. A computer-readable medium according to claim 47, wherein the integrity check comprises a Hashing Message Authentication Code (HMAC).
